(19) United States
(12) Patent Application Publication
(10) Pub. No.: US 2024/0070620 A1
(43) Pub. Date: Feb. 29, 2024

(54) CONSTRUCTION METHOD AND SYSTEM FOR ASSET VALUE MODELS IN DIGITAL TWIN ENGINE

(71) Applicant: STATE GRID JIANGSU ELECTRIC POWER CO., LTD NANJING POWER SUPPLY COMPANY, Jiangsu (CN)

(72) Inventors: Honghua XU, Jiangsu (CN); Weiya Zhang, Jiangsu (CN); Shaobin Sun, Jiangsu (CN); Gang Cao, Hiangsu (CN); Zhengyi Zhu, Jiangsu (CN); Jingzhou Xu, Jiangsu (CN); Shufan Wang, Jiangsu (CN); Ziqiang Xu, Jiangsu (CN); Mengjie Lv, Jiangsu (CN)

(73) Assignee: STATE GRID JIANGSU ELECTRIC POWER CO., LTD NANJING POWER SUPPLY COMPANY, Jiangsu (CN)

(21) Appl. No.: 18/366,618

(22) Filed: Aug. 7, 2023

(30) Foreign Application Priority Data
Aug. 24, 2022 (CN) 202211020098.8

(51) Int. Cl. G06Q 10/20; G06Q 10/0637; G06Q 10/067

(52) U.S. Cl. CPC G06Q 10/20; G06Q 10/06375; G06Q 10/067

(57) ABSTRACT

A construction method and system for asset value models in a digital twin engine includes: measuring the level of business importance based on a business model of building energy consumption assets, and constructing a first asset value model according to the business importance; establishing a correlation between the assets and productivity, and constructing a second asset value model according to productivity loss caused by the assets; and calculating the energy use efficiency of a building according to optimal decision variables, predicting the degradation index of the assets through the energy use efficiency, the first asset value model and the second asset value model, and generating a maintenance solution of the assets. The disclosed has ingenious conception and excellent effect, and realizes the accurate evaluation of the asset value by establishing the correlation between the assets and different businesses and different efficiency, generating the optimal and most accurate asset maintenance solution.

### CROSS-REFERENCE TO RELATED APPLICATION

This application claims the priority benefit of Chinese application serial no. 202211020098.8, filed on Aug. 24, 2022. The entirety of the above-mentioned patent application is hereby incorporated by reference herein and made a part of this specification.

### TECHNICAL FIELD

The present disclosure relates to the field of data processing, and more particularly to a construction method and system for asset value models in a digital twin engine.

### BACKGROUND ART

A building is composed of areas and assets that jointly serve some business functions and goals, and exists as a physical entity. A digital twin is a computer replica of the building physical entity, exists at the same time as the physical entity, seamlessly exchanges data, and can calculate the energy consumption of the building under different conditions. Connection of the physical entity with the digital twin is often conducive to achieving the goals of operation and planning. The process involves energy efficiency, asset performance, residential comfort and other user-customized measurement indexes.

However, the relevant data in a digital twin model is not fully used in the prior art, and it is difficult to effectively obtain the guidance solution for the use of relevant assets according to relevant data.

In view of the above problems, the present disclosure provides a construction method and system for asset value models in a digital twin engine.

### SUMMARY OF THE INVENTION

To overcome the shortcomings of the prior art, the present disclosure provides a construction method and system for asset value models in a digital twin engine, which can be used for predicting asset degradation and generating an asset maintenance solution by constructing a first asset value model and a second asset value model.

The present disclosure adopts the following technical solution.

A first aspect of the present disclosure relates to a construction method for asset value models in a digital twin engine, which includes the following steps: step 1. measuring the level of business importance based on a business model of building energy consumption assets, and constructing a first asset value model according to the business importance; step 2. establishing a correlation between the building energy consumption assets and productivity, and constructing a second asset value model according to productivity loss caused by the building energy consumption assets; and step 3. calculating the energy use efficiency of a building according to optimal decision variables, predicting the degradation index of the assets through the energy use efficiency, the first asset value model and the second asset value model, and generating a maintenance solution of the assets.

Preferably, the business model of the building energy consumption assets is: an operating state, asset loss and efficiency improvement of all energy consumption equipment in the building under different business requests.

Preferably, the business importance is the priority of the business request, and the business importance is determined by the comprehensive evaluation of the asset loss, regional efficiency improvement, regional priority, asset priority and business priority corresponding to the business.

Preferably, the correlation between the building energy consumption assets and the productivity includes a correlation between building energy consumption asset failure and efficiency loss, and a correlation between the efficiency loss and the productivity loss.

Preferably, the optimal decision variables include independent characteristic variables that have an impact on the operation of the building energy consumption assets, and the independent characteristic variables include an environment variable, a building construction plan variable and a building use target variable.

Preferably, the energy use efficiency of the building is determined by calculating the sum of the energy use power consumption of all the building energy consumption assets in the building on the premise that the independent characteristic variables are satisfied.

Preferably, with the independent characteristic variables as constraints, the optimal energy use solution of the building is determined according to the first asset value model and the second asset value model, and the energy use efficiency of the building is calculated based on the optimal solution.

Preferably, according to the maintenance solution, a transformation matrix between the building energy consumption assets is established to acquire the change relationship of the asset loss of other assets realized after the maintenance of a single asset.

Preferably, according to the transformation matrix between the building energy consumption assets and the degradation index of the assets, the optimal maintenance solution of the assets is generated.

A second aspect of the present disclosure relates to a construction system for asset value models in a digital twin engine, which is used for realizing the construction method for the asset value models in the digital twin engine in the first aspect of the present disclosure.

### BRIEF DESCRIPTION OF THE DRAWINGS

FIG. 1 is a step diagram of a construction method for asset value models in a digital twin engine of the present disclosure.

FIG. 2 is a schematic diagram of a first asset value model and a second asset value model in a construction method for asset value models in a digital twin engine of the present disclosure.

### DETAILED DESCRIPTION OF THE INVENTION

To make the purpose, the technical solution and advantages of the present disclosure clearer, the technical solution in the present disclosure will be clearly and fully described below in combination with the drawings in embodiments of the present disclosure. The embodiments described in the present application are merely part of the present disclosure, not all of the embodiments. Based on the spirit of the present disclosure, all other embodiments obtained by those ordinary skilled in the art without contributing creative labor will belong to the protection scope of the present disclosure.

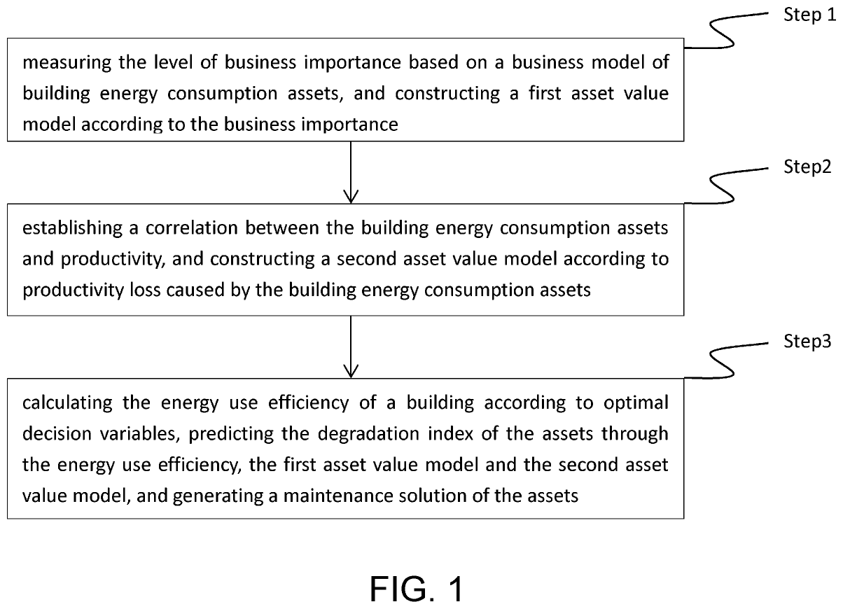

FIG. 1 is a step diagram of a construction method for asset value models in a digital twin engine of the present disclosure. As shown in FIG. 1, the first aspect of the present disclosure relates to a construction method for asset value models in a digital twin engine, which includes step 1 to step 3.

Step 1. measuring the level of business importance based on a business model of building energy consumption assets, and constructing a first asset value model according to the business importance.

It is understandable that the building energy consumption assets of the present disclosure may include energy consumption equipment used in a building to improve the indexes of the building, and the equipment may include various types of electrical and electronic equipment, and may also include all kinds of comprehensive equipment which can be reasonably applied to the building in the prior art or future technologies and can achieve energy conversion through solar energy and heat energy and generate efficiency. For example, air conditioning units, heating and ventilation equipment and the like.

The present disclosure can establish the corresponding digital twin engine, so as to analyze and process the various digital indexes involved in such equipment, to realize the reasonable invocation of the equipment in an optimal way under various circumstances and various objectives, so as to achieve the purpose of serving the good environment and efficiency of the building.

Preferably, the business model of the building energy consumption assets is: an operating state, asset loss and efficiency improvement of all energy consumption equipment in the building under different business requests.

It is easy to understand that the business model of the building energy consumption assets may include various ways in which the building energy consumption assets can achieve reasonable operation, such as the starting, shutdown, operation at different power consumption levels and frequency conversion operation of the air conditioning unit. Because the assets can correspond to different operating states and different loss and efficiency in the process of realizing different businesses, these indexes are also recorded in the asset business model.

It should be noted that the operating states of the assets may include, for example, the operating power of equipment such as air conditioners and the starting of various components. The loss condition may include the natural loss of the equipment during operation, for example, when the operating life of an air conditioner is determined, in a certain operating state, its service life will be reduced with the continuation of this state. In other words, when the air conditioner continues to operate in the current state for a long time, the present disclosure can judge when the air conditioner unit equipment needs to be detected, maintained or repaired.

Preferably, the business importance is the priority of the business request, and the business importance is determined by the comprehensive evaluation of the asset loss, regional efficiency improvement, regional priority, asset priority and business priority corresponding to the business.

It is understandable that the business importance described in the present disclosure can prioritize various of different businesses of the equipment, so that under the same circumstances, the business with higher equipment priority can be invoked to achieve reasonable operation of the equipment. For example, in order to ensure that the air conditioning units do not operate at ultra-high power and rapidly reduce the service life of the equipment when there are a plurality of air conditioning units in an area, the plurality of air conditioning units can be started at the same time and operated for a long time at lower power.

The method of the present disclosure can calculate the asset loss corresponding to the business, the performance improvement of an area of the building targeted by the equipment and other indexes according to each business operation mode of each equipment. Through the comprehensive analysis, the priority can be reasonably obtained. In the above indexes, the area priority represents whether the area corresponding to the equipment is an important area in the building. For example, if the area corresponding to the equipment is used as a public office area, and the area corresponding to another equipment is used as a parking lot, then in the case of insufficient power supply, the air conditioning equipment located in the public office area should have a relatively high priority in responding to the business requests.

In addition, the asset priority is used for representing the importance of a number of different equipment, for example, the importance of the air conditioning equipment is higher than those of various small sensor equipment and the like. Efficiency improvement means that for the same two pieces of equipment, under the condition that asset consumption degrees are similar, if one piece of equipment has a more obvious improvement effect on the environmental indexes to the building, the value of the regional efficiency improvement index is correspondingly higher.

In the present disclosure, the business priority can be understood as the importance between different business requests. For example, in the same area, the need for heating or cooling may be higher than the need for ventilation or air filtration. Therefore, in the same piece or the same class of equipment, the order of responding to different businesses can also be realized according to the business priority.

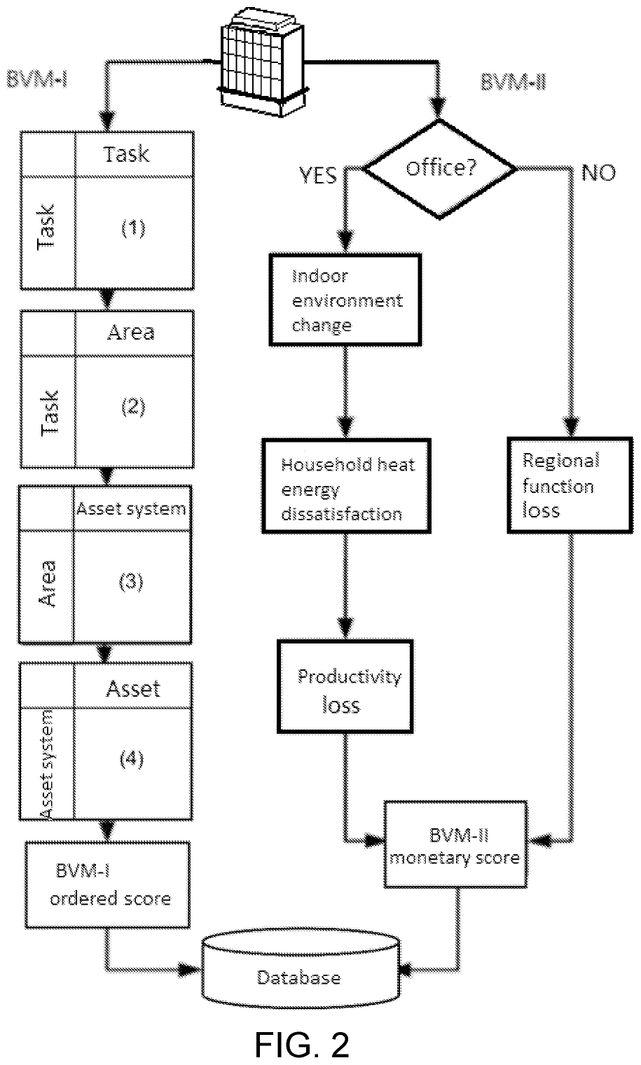

FIG. 2 is a schematic diagram of a first asset value model and a second asset value model in the construction method for the asset value models in the digital twin engine of the present disclosure. As shown in FIG. 2, the first asset value model in the present disclosure can automatically generate the priority of the business and sort the business after acquiring the relevant data of various business models of various kinds of equipment.

Step 2. establishing a correlation between the building energy consumption assets and productivity, and constructing a second asset value model according to productivity loss caused by the building energy consumption assets.

It is easy to understand that the building energy consumption assets cannot be directly correlated to the productivity. The productivity mentioned here mainly refers to the work efficiency of internal office staff or residential staff of the building in which the building energy consumption assets are located under the influence of various environmental factors, and of course, can also include the productivity, for example, generated in production and manufacturing of various products in the normal operation process of various types of equipment in the building.

In order to achieve the correlation between the operation of the energy consumption assets and the productivity, the efficiency of the energy consumption assets is considered as an intermediate variable to establish the correlation in the present disclosure.

Preferably, the correlation between the building energy consumption assets and the productivity includes a correlation between building energy consumption asset failure and efficiency loss, and a correlation between the efficiency loss and the productivity loss.

It is understandable that in the present disclosure, the correlation between the failure of the building energy consumption assets and the efficiency loss can consider the loss of the total energy efficiency of the building when an asset fails. For example, when the air conditioning unit in a certain area of the building is malfunction and cannot generate the corresponding heating or cooling, the environmental temperature will reduce the working efficiency of the personnel in a certain office area, and also lead to the abnormal operation of some factory equipment, resulting in the risk of failure. In the present disclosure, the abnormal environmental temperature can be used as an important factor in converting the efficiency loss index, and the failure risk of the factory equipment can also be converted into a part of the efficiency loss index. In this way, the correlation between the assets and the efficiency is obtained.

On the other hand, when the efficiency index is obtained, the productivity loss can be further obtained according to the efficiency index. For example, when there is a 10% possibility that the factory equipment is out of service, the product of the total time the equipment is out of service and the total yield of the equipment can further represent the loss of the productivity. In this way, the direct correlation between the assets and the productivity can be quantified and visually obtained in the present disclosure.

It can be seen that the second asset value model in fact realizes the analysis of the importance of the assets through the correlation between the energy consumption assets and the productivity.

Step 3, calculating the energy use efficiency of a building according to optimal decision variables, predicting the degradation index of the assets through the energy use efficiency, the first asset value model and the second asset value model, and generating a maintenance solution of the assets.

Preferably, the optimal decision variables include independent characteristic variables that have an impact on the operation of the building energy consumption assets, and the independent characteristic variables include an environment variable, a building construction plan variable and a building use target variable.

In the process of acquiring the optimal resource use solution, it is necessary to establish the constraints according to the influence of various factors such as environment. Such constraints in the present disclosure are referred to as optimal decision variables. Specifically, the variables may include multiple different and completely independent characteristic variables, such as weather conditions, temperature, humidity, light conditions, etc., may also include the maintenance or construction plan of the building itself and the shutdown and maintenance conditions of various types of equipment, and may also include various factors such as use goals of the building or user satisfaction indexes. The constraints of these indexes can be established in a quantitative way, for example, it is still ensured that the environmental temperature of the area inside the building is 25° C. when the atmospheric temperature is 35° C.

Preferably, with the independent characteristic variables as constraints, the optimal energy use solution of the building is determined according to the first asset value model and the second asset value model, and the energy use efficiency of the building is calculated based on the optimal solution.

In the present disclosure, the optimal decision variable can be used as a constraint to reasonably select the use and control modes of the assets. For example, in order to reduce the temperature in an area, the use of some equipment with high heat can be selected to be reduced, or it can be considered to increase the use power of the air conditioner. By taking the optimal decision variable as the constraint and using the model generated in step 1 and step 2, the optimal business mode can be selected from various of different business modes.

In the present disclosure, the optimal solution is selected from all solutions, and all the solutions are essentially permutations and combinations of the business states of each equipment. After the invalid solutions are excluded through the constraint, the solutions can be sorted through two models in the present disclosure, and the solution with the highest ranking automatically becomes the optimal solution in the present disclosure.

After the optimal solution is acquired, the energy use efficiency of the building can be determined according to different business states of the different equipment involved in the solution. The power of the current equipment in each business is summed to obtain the total power consumption of the optimal solution.

Preferably, according to the maintenance solution, a transformation matrix between the building energy consumption assets is established to acquire the change relationship of the asset loss of other assets realized after the maintenance of a single asset. Preferably, according to the transformation matrix between the building energy consumption assets and the degradation index of the assets, the optimal maintenance solution of the assets is generated.

It is understandable that the maintenance solutions in the present disclosure are also diverse. Although the total energy consumption of the optimal solution and the loss of each equipment can be obtained, because different maintenance solutions can lead to the recovery of the loss of multiple assets in different degrees, the transformation matrix can be established in the method of the present disclosure. The matrix is

$$δ ( T ; k , l ) = [ \begin{matrix}{δ}_{11} & {δ}_{12} & … & {δ}_{1 n} \\ {δ}_{21} & {δ}_{22} & … & {δ}_{2 n} \\ ⋮ & ⋮ & ⋱ & ⋮ \\ {δ}_{n 1} & {δ}_{n 2} & … & {δ}_{nn}\end{matrix} ] ∀ ( T ; k , l )$$

In the matrix, any maintenance solution (T; k, l) can have associated characteristics among all kinds of equipment. For example, when the first equipment is repaired and the service life is increased by 1 year, the second equipment will be correspondingly increased by the service life of δ₁₂ time. Therefore, according to the transformation matrix, regardless of the maintenance solution, the increase of the corresponding service life of all the equipment can be easily calculated, so as to select the optimal solution in multiple maintenance solutions. In the present disclosure, T; k, l are asset life, maintenance type and asset number respectively.

The second aspect of the present disclosure relates to a construction system for asset value models in a digital twin engine, which is used for realizing the construction method for the asset value models in the digital twin engine in the first aspect of the present disclosure. The present disclosure has the beneficial effects that, compared with the prior art, the construction method and system for the asset value models in the digital twin engine of the present disclosure can predict asset degradation and generate the asset maintenance solution by constructing the first asset value model and the second asset value model. The present disclosure has ingenious conception and excellent effect, and realizes the accurate evaluation of the asset value by establishing the correlation between the assets and different businesses and different efficiency, so as to generate the optimal and most accurate asset maintenance solution.

The present disclosure also includes the following beneficial effects:

1. The first asset value model in the present disclosure is established according to the priority of different businesses. Because the effects achieved by different businesses and the consumption cost of the energy consumption assets are different on the premise of the same or similar energy consumption loss, the business importance and the priority can be well analyzed by establishing the first asset value model. Under the same building use needs, the optimal and most suitable business can be selected, and the degradation index and the maintenance solution of the assets are obtained on this basis, thereby saving the use waste of the building energy consumption assets to the largest degree.

2. In the prior art, it is usually difficult to actual evaluate the consumption caused by the building energy consumption assets, and it is impossible to measure the value generated by the building energy consumption assets. In the present application, various feelings of a user in the building are converted into the productivity indexes, and the quantitative correlation between the productivity indexes and the building energy consumption assets is realized, so as to targetedly acquire the reasonable use solution of the assets.

3. The method of the present disclosure realizes the calculation of the energy use efficiency of the assets through the first and second asset value models. On this basis, the correlation of loss increase and decrease among multiple resources caused by various maintenance solutions is acquired by establishing the transformation matrix, so as to obtain the optimal maintenance plan for the assets at a global level that considers all the assets.

It should be finally noted that the above embodiments are only used for describing, rather than limiting the technical solution of the present disclosure. Although the present disclosure is described in detail with reference to the above embodiments, those ordinary skilled in the art shall understand that the specific embodiments of the present disclosure can be amended or equivalently replaced. Any amendment or equivalent replacement without departing from the spirit and the scope of the present disclosure shall be covered within the protection scope of the claims of the present disclosure.

What is claimed is:

1. A construction method for asset value models in a digital twin engine, comprising the following steps:
step 1. measuring a level of business importance based on a business model of building energy consumption assets, and constructing a first asset value model according to the business importance;
step 2. establishing a correlation between the building energy consumption assets and productivity, and constructing a second asset value model according to productivity loss caused by the building energy consumption assets; and
step 3. calculating an energy use efficiency of a building according to optimal decision variables, predicting a degradation index of the assets through the energy use efficiency, the first asset value model and the second asset value model, and generating a maintenance solution of the assets.

2. The construction method for the asset value models in the digital twin engine according to claim 1, wherein
the business model of the building energy consumption assets is: an operating state, asset loss and efficiency improvement of all energy consumption equipment in the building under different business requests.

3. The construction method for the asset value models in the digital twin engine according to claim 2, wherein
the business importance is a priority of the business request, and the business importance is determined by the comprehensive evaluation of the asset loss, regional efficiency improvement, regional priority, asset priority and business priority corresponding to the business.

4. The construction method for the asset value models in the digital twin engine according to claim 3, wherein
the correlation between the building energy consumption assets and the productivity comprises a correlation between building energy consumption asset failure and efficiency loss, and a correlation between the efficiency loss and the productivity loss.

5. The construction method for the asset value models in the digital twin engine according to claim 4, wherein
the optimal decision variables comprise independent characteristic variables that have an impact on the operation of the building energy consumption assets; and
the independent characteristic variables comprise an environment variable, a building construction plan variable and a building use target variable.

6. The construction method for the asset value models in the digital twin engine according to claim 5, wherein
the energy use efficiency of the building is determined by calculating the sum of the energy use power consumption of all the building energy consumption assets in the building on the premise that the independent characteristic variables are satisfied.

7. The construction method for the asset value models in the digital twin engine according to claim 6, wherein
with the independent characteristic variables as constraints, the optimal energy use solution of the building is determined according to the first asset value model and the second asset value model, and the energy use efficiency of the building is calculated based on the optimal solution.

8. The construction method for the asset value models in the digital twin engine according to claim 7, wherein
according to the maintenance solution, a transformation matrix between the building energy consumption assets is established to acquire the change relationship of the asset loss of other assets realized after the maintenance of a single asset.

9. The construction method for the asset value models in the digital twin engine according to claim 8, wherein
according to the transformation matrix between the building energy consumption assets and the degradation index of the assets, the optimal maintenance solution of the assets is generated.

10. A construction system for asset value models in a digital twin engine, wherein
the construction system is used for realizing the construction method for the asset value models in the digital twin engine according to claim 1.

11. A construction system for asset value models in a digital twin engine, wherein
the construction system is used for realizing the construction method for the asset value models in the digital twin engine according to claim 2.

12. A construction system for asset value models in a digital twin engine, wherein
the construction system is used for realizing the construction method for the asset value models in the digital twin engine according to claim 3.

13. A construction system for asset value models in a digital twin engine, wherein
the construction system is used for realizing the construction method for the asset value models in the digital twin engine according to claim 4.

14. A construction system for asset value models in a digital twin engine, wherein
the construction system is used for realizing the construction method for the asset value models in the digital twin engine according to claim 5.

15. A construction system for asset value models in a digital twin engine, wherein
the construction system is used for realizing the construction method for the asset value models in the digital twin engine according to claim 6.

16. A construction system for asset value models in a digital twin engine, wherein
the construction system is used for realizing the construction method for the asset value models in the digital twin engine according to claim 7.

17. A construction system for asset value models in a digital twin engine, wherein
the construction system is used for realizing the construction method for the asset value models in the digital twin engine according to claim 8.

18. A construction system for asset value models in a digital twin engine, wherein
the construction system is used for realizing the construction method for the asset value models in the digital twin engine according to claim 9.
